(19) United States
(12) Patent Application Publication
(10) Pub. No.: US 2006/0247978 A1
(43) Pub. Date: Nov. 2, 2006

(54) Apparatus and method for creating and facilitating the use of a remotely accessible library of affinity-type shopping memberships for use in remote shopping

(76) Inventor: Philip J. Davis, Walpole, NH (US)

Correspondence Address: THE MARTINEZ GROUP PLLC;Mark Sgantzos, Suite 1-D, 55 Poplar Street, Brooklyn Heights, NY, 11201-6930, US

(21) Appl. No.: 11/413,892

(22) Filed: Apr. 28, 2006

Related U.S. Application Data
(60) Provisional application No. 60/681,133, filed on Apr. 28, 2005.

(51) Int. Cl. G06Q 30/00

(52) U.S. Cl. 705/26

(57) ABSTRACT

An apparatus and method for creating a frequent shopper type or consumer affinity type relationships for remote consumer transactions where the consumer creates a remotely accessible library for affinity type shopping memberships for use in remote shopping for creating efficient access to a consumer's favored shopping locations. The locations can be easily accessible on the consumer's computer system by way of a toolbar having a shopping link or hyperlink.

### RELATED APPLICATIONS

This application claims the benefit of priority of U.S. Provisional Patent Application Ser. No. 60/681,133 filed on Apr. 28, 2005, and entitled METHOD AND PROCESS FOR PROVIDING ELECTRONIC CONSUMER AFFINITY CARDS, the subject matter of which is hereby incorporated by reference herein.

### FIELD OF THE INVENTION

The present invention pertains to an apparatus and method for creating and facilitating the use of frequent shopper-type or consumer affinity-type shopping and frequent shopper type relationships and remote consumer transactions and information, in particular, to an apparatus and a method for permitting remote consumer transactions and information using frequent shopper type or consumer affinity-type relationships, whereby the consumer creates a remotely accessible library of frequent shopper-type or consumer affinity-type memberships for use in remote shopping for the purposes of creating efficient access to a consumer's favored shopping locations and for the purposes of reducing costs to Internet advertisers by eliminating or reducing the search fees charged to advertisers by Internet search engine providers.

### BACKGROUND OF THE INVENTION

Consumer affinity cards are a form of frequent shopper cards that are used in the retail industry to create customer loyalty by rewarding consumers for their patronage. Typically, such rewards include price discounts and discounts made on preferred basis to loyal customers. Such affinity or frequent shopper cards also reward the issuing retail establishments by generating additional purchasing by those consumers holding such cards. The most common form of frequent shopper type affinity cards are those issued by merchants for use directly at the point of purchase of goods at the merchant's store. For example, merchants such as CVS provide frequent shopper affinity cards such as the Extra Bucks card and the Extra Care pharmacy card which offer cash back, coupons and other benefits to frequent shoppers as a method of creating and maintaining customer affinity. Staples offers the Rewards frequent shopper program which offers discounts to in-store and online purchasers. The Super Fresh grocery store chains have the Club Fresh discount card, which offer numerous benefits and discounts to frequent shoppers as a method of creating, maintaining and building consumer affinity. In addition to merchant affinity cards, which third party affinity cards are credit card type affinity card wherein issuers of a credit card display a manufacturer's brand or merchants store brand on a credit card or place life-style messages or images on the card to appeal to a group of consumers having common interests or memberships in particular groups or organizations or who otherwise share a common interest, activity or emotional or intellectual interest.

Prior art systems are known which comprise accrual programs that reward usage of credit cards and affinity cards for purchases by rewarding a card holder for purchasing by issuing rebates, redeemable program points or transmitting a small donation to the institution or group identified on the affinity card. Typically, such rewards are based upon total volume of purchasing or the value of the purchasing either as cash transactions or credit issued to the card holder. However, many of the benefits that businesses have traditionally experienced by the use of these proprietary systems have been reduced or entirely lost due to the growth of consumer shopping via the Internet. In order to remain competitive, merchants are now forced to join and maintain advertising programs on the Internet, the most popular of which is the use of advertisements that are matched to Internet search engine inquiries. These types of search context sensitive advertisement programs are commonly used by Google® and Yahoo®, just to name a few and these programs have become hugely profitable. Obviously, those profits are derived from the fees that advertisers must pay each time their advertisement is shown on a website of interest to the searcher or, under the alternative system, each time a searcher clicks on (commonly referred to as “a click through”) an advertisement. Under these systems, a person using a search engine the Internet user/searcher bears no cost to conduct a search.

For the purposes of the placing of advertisements, these search engines employ a competitive bidding advertising system, forcing potential advertisers to bid both against their competition and their own financial self-interests, since competitive bidding tends to increase the cost of winning.

Under the competitive bidding search engine advertising systems described above, advertisers must pay a fee each time a consumer views an advertisement or clicks through an advertisement. In order to ensure that an advertisement will enjoy preferential viewing as the result of a search, an advertiser must bid against their competitors. As noted above, under such bidding systems, the advertiser is charged each time a person using the search engine “clicks on” or selects the advertisement placed by the advertiser or under a variation of such systems, each time an advertiser's message is viewed. The charge to the advertiser for this service is based upon the cost that the advertiser is willing to pay, multiplied by the “click through” rate. The click through rate is typically determined as the number of clicks an advertisement receives divided by the number of times the ad is displayed. Under such systems, an advertiser can elect to pay sums as little as fractions of a cent per click to as much as $100 or more, per click. In a variation of the click through system described above, an advertiser bids for the placement of their advertisements and is then charged when the advertisement is merely displayed. This alternative systems is intended to ensure that an advertisement is viewed, obviating the need to a potential consumer to actually click through the advertisement. Under either system, an advertiser willing to spend more will enjoy a more favorable advertisement placement whenever a consumer's search includes terms that may be relevant to the goods or services being advertised.

While beneficial to the profitability of such search engines, the growing consumer practice of using an Internet search engine to find goods or a particular merchant rather than storing or bookmarking the merchant's URL or web address has resulted in additional costs to merchant/advertisers and the loss of customer loyalty. Furthermore, in order to maintain or increase a favorable advertising position a merchant is forced to incur additional and often increasing fees. This system results in an advertising charge to a merchant even when the person casually clicking or reviewing on a search result has no interest in purchasing. More troubling, the search engine bidding-type advertising systems do nothing to foster consumer loyalty. It is likely that such search engine based advertising systems are likely to become more popular. In particular, because the search results are returned so quickly, consumers do not feel compelled to record their search terms or “bookmark” any particular result since searches are so easily duplicated. Advertisers are thereby forced to continue advertising to ensure that their goods or services are available for viewing without the benefit of customer loyalty that is engendered by the in-store visit and purchase using a store issued affinity card. Furthermore, search engine advertising usually results in a merchants advertising being seen in close proximity to the merchant's competitors. Finally, such search engine type systems neither permit nor provide a method of using or delivering a consumer specific frequent shopper purchasing incentives or marketing messages and advertising related to a consumer's purchasing preferences or habits directly to such consumers.

Applicant hereby incorporates by reference herein the subject matter of the Agent Sourcebook, A Complete Guide to Desktop, Internet and Intranet Agents, by Alper Caglayan and Colin Harrison, Wiley Computer Publishing, 1997. Applicant also incorporates by reference herein the subject matter of Cool Intelligent Agents For The Net, by Leslie L. Lesnick with Ralph E. Moore, IDG Books Worldwide, Inc. 1997.

Applicant hereby incorporates by reference herein the subject matter and teachings of the following U.S. patents: U.S. Pat. No. 5,991,740 which teaches a data processing system for integrated tracking and management of commerce related activities on a public access network; U.S. Pat. No. 5,848,396 which teaches a method and apparatus for determining behavioral profile of a computer user; U.S. Pat. No. 5,537,314 which teaches a referral recognition system for an incentive award program; U.S. Pat. No. 5,692,206 which teaches a method and apparatus for automating the generation of a legal document; U.S. Pat. No. 5,708,780 which teaches an Internet server access control and monitoring systems; U.S. Pat. No. 5,712,979 which teaches a method and apparatus for attaching navigational history information to universal resource locator links on a world wide web page; U.S. Pat. No. 5,715,315 which teaches CATV systems; U.S. Pat. No. 5,724,424 which teaches digital active advertising; U.S. Pat. No. 5,903,830 which teaches a transaction security apparatus and method; and U.S. Pat. No. 5,878,337 which teaches a transaction security apparatus and method. The present invention, in any and/or all of the embodiments described herein, hereby incorporates the teachings of, and can utilize the teachings of, the above-identified U.S. patents as well as improve upon the teachings of the above-identified U.S. patents.

### SUMMARY OF THE PRESENT INVENTION

As used herein, the terms “individual,” “user,” “customer,” “client,” and/or the plural of same, refer to any individuals, users, customers, clients, and/or other parties and/or entities, who or which utilize the apparatus and method of the present invention so as to locate, find, buy, or purchase any good(s) or service(s) via any the affiliated marketing relationship described herein.

As used herein, the terms “Web Site owner,” “Site owner,” “Advertising Provider,” “Site,” “Marketing site,” and/or the plural of same, refer to any web site owners, site owners, content providers, referring sites, marketing sites, and/or other parties and/or entities, who or which utilize the apparatus and method of the present invention in order to provide frequent shopper affiliated marketing links and/or to any of the merchants, sellers, and/or vendors, described herein in order to effectuate any affiliated marketing model relationship described herein.

As used herein, the terms “merchant,” “seller,” “vendor,” “marketer,” “advertiser,” or the plural of same, refers to any merchants, sellers, vendors, marketers, advertisers and/or other parties and/or entities who or which sell, advertise or market goods and/or services which are sold, leased, traded, and/or which can otherwise be the subject matter of, and/or be involved in, a transaction which results from any of the frequent shopper affiliated marketing relationships described herein.

The present invention pertains to an apparatus and a method for providing a frequent shopper library tool bar and creating and maintaining affinity marketing relationships. In particular, the present invention provides an apparatus and a method for effectuating, providing, and/or facilitating a frequent shopper library and affinity marketing relationship which can provide for the monitoring, the tracking, and/or the management, of merchant/consumer relationships, referral relationships, and/or other commerce-related and/or marketing relationships and/or activities. The apparatus and method of the present invention can be utilized in a network environment and/or otherwise in any other suitable environment.

The present invention provides an apparatus and a method for allowing parties and/or entities of any kind or type to create a library of frequent shopper hyperlinks on the computer/processor of a consumer and to facilitate the consumers entry into affiliated marketing relationships, whereby one or more parties and/or entities refers individuals and/or users to merchants or vendors in order to facilitate a sale of, and/or other transactions involving, goods and/or services which are offered by and/or provided by a merchant or vendor.

The present invention facilitates the data processing and/or other processing and/or communication activities for ensuring that an electronic frequent shopper/affiliated marketing relationship is created and otherwise satisfies and/or fulfills the respective needs of the parties or entities thereto.

The apparatus and method of the present invention can provide for the monitoring and/or for the tracking of the an individual consumer's creation, use and shopping activities, including the visiting of web sites and/or links which the individual visited, utilized, and/or navigated through, in his or her being linked to, or being brought into contact with, the merchant and/or vendor, thereby identifying the computers and/or web sites, and/or links, which are and/or which can be used as the basis for transmitting shopping offers, frequent purchaser rewards and/or the transmission of advertising by means of installing an electronic affinity frequent shopper account toolbar on an account holder's computational apparatus which can include at least one of a personal computer PDA or mobile phone and can include any device which can provide internet access. The toolbar having a shopping link or hyperlink in order to avoid a fee to a search engine due to a click through.

The present invention pertains to an apparatus and method for providing frequent shopper account library software for use by consumers to overcome the use of search engine computer systems to find and access shopping locations on the Internet.

The present invention pertains to an apparatus and method for providing marketing, advertisement, and/or promotional, materials with a frequent shopper account library statement information which overcomes the deficiencies of the prior art.

The present invention pertains to an apparatus and method for providing marketing, advertisement, and/or promotional, materials with account statement information for frequent shopper library accounts involving providing correspondence to account holders.

The apparatus and method of the present invention can provide marketing, advertisement, and/or promotional, materials and/or information, together with and/or in conjunction with, frequent shopper library account statement correspondence. The apparatus and method of the present invention can provide marketing, advertisement, and/or promotional, materials and/or information, in hardcopy form, in electronic form, and/or in any combination of same.

The apparatus and method of the present invention can also provide marketing, advertisement, and/or promotional, materials and/or information, which can be pre-selected for an frequent shopper library account or a frequent shopper library account holder and/or which can be individually suited and/or customized for a particular library account or library account holder based upon information regarding a particular library account, a particular library account holder, and/or a particular merchant, advertiser, promoter, and/or any other provider of any goods, products, and/or services.

The apparatus and method of the present invention can also provide marketing, advertisement, and/or promotional, materials and/or information to a medical link selected from a frequent shopper library account or frequent shopper library account holder and/or individual in which a user can order medication from private or government sponsored healthcare programs which provide medication purchasing programs.

The apparatus of the present invention includes a central processing computer which can perform processing routines and/or processing operations for providing frequent shopper library connections and marketing materials and/or information, advertising materials and/or information, or promotional materials and/or information, together with and/or in conjunction with frequent shopper account information or correspondence, or account statement information or correspondence.

The apparatus of the present invention can also include one of more merchant computers which can be associated with can one or more of merchants, vendors, or providers, of any goods, products, or services, which can be the subject to commerce.

The apparatus of the present invention can also include one of more advertiser computers which can be associated with one or more of merchants, vendors, or providers, of any goods, products, or services, advertisers, who or which can provide and/or be responsible for providing and/or causing to be provided any of the marketing materials and/or information, advertising materials and/or information, and/or promotional materials and/or information.

The apparatus of the present invention can also include one of one or more user communication devices which can be associated with can one or more of the herein-described users or individuals.

The present invention can be utilized on, over, and/or in conjunction with, any suitable communication network or system, including, but not limited to the Internet, the World Wide Web, a telephone network, a telecommunication network, a digital communication network, a satellite communication network, a wireless communication network, a personal communication services network, a broadband communication network, a bluetooth communication network, and/or any other communication network and/or system.

The present invention can be utilized in order to provide marketing materials or information, advertising materials or information, promotional materials or information, and/or offering materials or information, for or regarding any goods, products, services, information, for any of the above goods, products, services, and/or information, of any kind or type, along with and/or in conjunction with and/or with any frequent shopper library account, frequent shopper library account correspondence, frequent shopper library account statements, frequent shopper library account statement correspondence, and/or any other frequent shopper library account-related communication and/or correspondence.

The respective marketing materials or information, advertising materials or information, promotional materials or information, and/or offering materials or information, as well as the associated, corresponding, and/or underlying frequent shopper library account correspondence, frequent shopper library account statements, frequent shopper library account statement correspondence, and/or any other frequent shopper library account-related communication and/or correspondence, can be generated, produced and sent, transmitted, and/or disseminated in hard copy form, such as in the form of hardcopy printed statements, communications, correspondence, marketing materials, advertisement materials, and/or promotional material, which can be sent via physical delivery, and/or can be generated, produced and sent, transmitted, and/or disseminated in electronic form, such as in the form of electronic statements, communications, correspondence, marketing materials, advertisement materials, and/or promotional material, which can be sent via electronic transmission, facsimile transmission, electronic mail (e-mail) message transmission, instant messaging message transmission, text-message, and/or via any other electronic or digital transmission.

The present invention can await and/or detect the generation of any one or more of a frequent shopper library account correspondence, a frequent shopper library account statement, a frequent shopper library account statement correspondence, and/or any other frequent shopper library account-related communication and/or correspondence, for a particular account.

The present invention can also generate and/or produce the respective frequent shopper library account correspondence, frequent shopper library account statement, frequent shopper library account statement correspondence, and/or any other account-related communication and/or correspondence, and either print same out in hard copy form and/or store same in electronic form.

The present invention can also identify the particular marketing materials or information, advertising materials or information, and/or promotional materials or information, which are to be provided with, or in conjunction with, the respective frequent shopper library account, frequent shopper library account correspondence and/or any other frequent shopper library account-related communication and/or correspondence, for the particular account.

The present invention can generate or produce the respective marketing materials or information, advertising materials or information, and/or promotional materials or information. The respective marketing materials or information, advertising materials or information, and/or promotional materials or information, can be generated in hard copy form, such as by printing the respective materials or information out on a printer, or in electronic form.

The present invention can output or produce hard copies of the frequent shopper library account correspondence(s), frequent shopper library account statement(s), and/or any other frequent shopper library account-related communication(s) and/or correspondence(s).

The present invention can also provide the respective frequent shopper library account correspondence(s), frequent shopper library account statement correspondence(s), and/or any other frequent shopper library account-related communication(s) and/or correspondence(s), and the respective marketing materials or information, advertising materials or information, and/or promotional materials or information, with identification and/or tracking information for tracking the use and/or effectiveness of the respective marketing materials or information, advertising materials or information, and/or promotional materials or information.

The present invention can also process transactions involving, orders for, and/or purchases for, any goods, products, services, information, which can be the subject of any of the respective marketing materials or information, advertising materials or information, and/or promotional materials or information.

The present invention can also process an affiliated marketing relationship and/or an in-store affinity relationship.

The respective marketing materials or information, advertising materials or information, promotional materials or information, and/or offering materials or information, as well as the associated, corresponding, and/or underlying frequent shopper library account correspondence, frequent shopper library account statements, frequent shopper library account statement correspondence, and/or any other frequent shopper library account-related communication and/or correspondence, can be generated, produced and sent, transmitted, and/or disseminated in electronic form.

The respective marketing materials or information, advertising materials or information, and/or promotional materials or information, can contain links or hyperlinks to any of the merchants, providers, vendors, marketers, advertisers, and/or can contain links and/or hyperlinks to any information pertaining to any of the goods, products, services, information, other entities, businesses or which are being featured in, and/or which are being marketed, advertised, and/or promoted, in or by the respective marketing materials or information, advertising materials or information, and/or promotional materials or information.

The respective frequent shopper library account correspondence(s), frequent shopper library account statement(s), frequent shopper library account statement correspondence(s), and/or any other frequent shopper library account-related communication(s) and any associated or relevant marketing materials or information, advertising materials or information, and/or promotional materials or information, can be generated as any one or more of e-mail messages and/or electronic message attachments.

The present invention can also process transactions involving orders for, and/or purchases any of the goods, products, services, and/or information, which can be the subject of any of the respective marketing materials or information, advertising materials or information, and/or promotional materials or information.

The present invention can be utilized to market, advertise, promote, sell any goods, products, services, information, which can be the subject of commerce and/or of a transaction, and/or can be utilized in order to market, advertise, promote, sell or lease, subscriptions for any of the above-described goods, products, services, information, magazines, periodicals, newspapers, newsletters.

The present invention can also provide notification of the scheduled sending, transmission, and/or dissemination, and/or of the actual sending, transmission, and/or dissemination, of any of the herein-described account bills, account correspondences, account billing correspondences, account billing statements, account statements, account statement correspondences, and/or any other account-related communications and/or correspondences, and the respective marketing materials or information, advertising materials or information, and/or promotional materials or information.

The present invention can also be utilized in order to disseminate sales offerings for any of the goods of interest to the frequent shopper library account holder or for any of the above-described goods, products, services, or information.

The apparatus and method of the present invention can be utilized in order to facilitate repeat transactions between any of the herein-described users, individuals, frequent shopper library account holder's, frequent shopper library accounts owners, merchants, providers and vendors.

Accordingly, it is an object of the present invention to provide an apparatus and method for providing a frequent shopper library, marketing, advertisement, and/or promotional, materials along with, or in conjunction with, frequent shopper library account information and/or account statement information.

It is still another object of the present invention to provide an apparatus and method which can provide marketing, advertisement, and/or promotional, materials and/or information, in hard copy form, together with and/or in conjunction with, frequent shopper library account information, frequent shopper library account statement information, frequent shopper library account statements, and/or frequent shopper library account statement correspondence.

It is yet another object of the present invention to provide an apparatus and method which can provide marketing, advertisement, and/or promotional, materials and/or information, in electronic form, together with and/or in conjunction with, frequent shopper library account information, frequent shopper library account statement information, frequent shopper library account statements, and/or frequent shopper library account statement correspondence.

It is another object of the present invention to provide an apparatus and method for providing marketing, advertisement, and/or promotional, materials together with, or in conjunction with, frequent shopper library account statement information which can pre-select, customize, and/or custom-select the marketing, advertisement, and/or promotional, materials for a particular frequent shopper library account or frequent shopper library account holder.

It is still another object of the present invention to provide an apparatus and method for providing marketing, advertisement, and/or promotional, materials together with, or in conjunction with frequent shopper library account statement information which can be utilized on, over, and/or in conjunction with, any suitable communication network or system.

It is yet another object of the present invention to provide an apparatus and method for providing marketing, advertisement, and/or promotional, materials together with, or in conjunction with, frequent shopper library account statement information which can be utilized on, over, and/or in conjunction with, the Internet and/or the World Wide Web.

It is another object of the present invention to provide an apparatus and method for providing marketing, advertisement, and/or promotional, materials together with, or in conjunction with, frequent shopper library statement information which can be utilized on, over, and/or in conjunction with, any suitable wireless communication network or system.

It is still another object of the present invention to provide an apparatus and method for providing marketing, advertisement, and/or promotional, materials together with, or in conjunction with, frequent shopper library account statement information which can detect the generation of any one or more an frequent shopper library an account correspondence, a frequent shopper library account statement, a frequent shopper library account statement correspondence, and/or any other frequent shopper library account-related communication and/or correspondence.

It is yet another object of the present invention to provide an apparatus and method for providing marketing, advertisement, and/or promotional, materials together with, or in conjunction with, frequent shopper library account statement information which can generate and/or produce a frequent shopper library account correspondence, a frequent shopper library account statement, a frequent shopper library account statement correspondence, and/or any other frequent shopper library account-related communication and/or correspondence.

It is another object of the present invention to provide an apparatus and method for providing marketing, advertisement, and/or promotional, materials together with, or in conjunction with, frequent shopper library account statement information which can identify the respective marketing materials or information, advertising materials or information, and/or promotional materials or information that are of interest to the frequent shopper library account holder.

It is still another object of the present invention to provide an apparatus and method for providing marketing, advertisement, and/or promotional, materials along with, or in conjunction with, frequent shopper library account statement information which can identify or select pre-selected or pre-requested marketing materials or information, advertising materials or information, and/or promotional materials or information that is of interest to the frequent shopper library account holder.

It is yet another object of the present invention to provide an apparatus and method for providing marketing, advertisement, and/or promotional, materials along with, or in conjunction with, frequent shopper library account statement information which can target or schedule the respective marketing materials or information, advertising materials or information, and/or promotional materials or information, for dissemination to frequent shopper library account holders or frequent shopper library account owners.

It is another object of the present invention to provide an apparatus and method for providing marketing, advertisement, and/or promotional, materials along with, or in conjunction with, frequent shopper library account statement information which can generate or produce the marketing materials or information, advertising materials or information, and/or promotional materials or information that are related to the frequent shopper library statement account contents.

It is still another object of the present invention to provide an apparatus and method for providing marketing, advertisement, and/or promotional, materials together with, or in connection with, frequent shopper library account statement information which can generate or produce the respective marketing materials or information, advertising materials or information, and/or promotional materials or information, in printed form.

It is yet another object of the present invention to provide an apparatus and method for providing marketing, advertisement, and/or promotional, materials together with, or in conjunction with, a frequent shopper library account statement information which can generate or produce the respective marketing materials or information, advertising materials or information, and/or promotional materials or information, in electronic form, as an electronic mail message or an electronic mail attachment.

It is still another object of the present invention to provide an apparatus and method for providing marketing, advertisement, and/or promotional, materials together with, or in conjunction with, frequent shopper library account statement information which can process the respective materials or information for transmission to a frequent shopper library account holder or a frequent shopper library account owner.

It is yet another object of the present invention to provide an apparatus and method for providing marketing, advertisement, and/or promotional, materials together with, or in conjunction with, frequent shopper library account statement information which can provide identification and/or tracking information on the respective materials or information for tracking the usage and/or effectiveness of same.

It is another object of the present invention to provide an apparatus and method for providing marketing, advertisement, and/or promotional, materials together with, or in conjunction with, frequent shopper library account statement information which can process transactions involving any goods, products, services, information, which are the subject of the respective materials or information.

It is another object of the present invention to provide an apparatus and method for providing marketing, advertisement, and/or promotional, materials together with, or in conjunction with, frequent shopper library account statement information which can provide links or hyperlinks to merchants, providers, vendors, marketers, advertisers, and/or promoters.

It is still another object of the present invention to provide an apparatus and method for providing marketing, advertisement, and/or promotional, materials together with, or in conjunction with, frequent shopper library account statement information which can provide links and/or hyperlinks to any information pertaining to any of the goods, products, services, information, magazines, periodicals, and/or other entities which are featured in any of the respective materials or that are of interest to the frequent shopper library account holder.

It is yet another object of the present invention to provide an apparatus and method for providing marketing, advertisement, and/or promotional, materials together with, or in conjunction with, frequent shopper library account statement information which can provide notification of the pre-determined sending, transmission, and/or dissemination, and/or of the actual sending, transmission, and/or dissemination, of frequent shopper library account correspondences, account statements, frequent shopper library account statement correspondences, and frequent shopper library account-related communications and/or correspondences, and the respective marketing materials or information, advertising materials or information, and/or promotional materials or information.

Other objects and advantages of the present invention will be apparent to those skilled in the art upon a review of the Description of the Preferred Embodiments taken in conjunction with the Drawings which follow.

### BRIEF DESCRIPTION OF THE DRAWINGS

FIG. 1 illustrates a preferred embodiment of the apparatus of the present invention, in block diagram form;

FIG. 2 illustrates another preferred embodiment of the apparatus of the present invention, in block diagram form; and

FIGS. 3A and 3B illustrate a preferred embodiment operation of the apparatus of FIG. 1, in flow diagram form.

### DESCRIPTION OF THE PREFERRED EMBODIMENTS

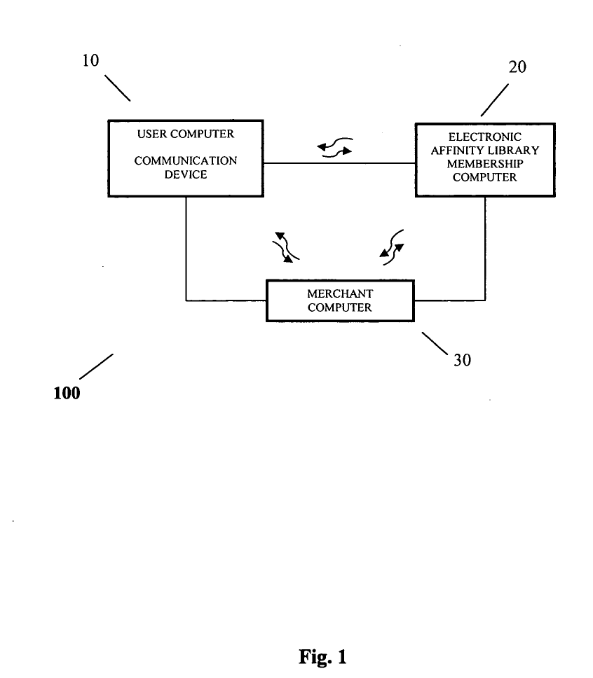

FIG. 1 illustrates a preferred embodiment of the apparatus of the present invention, which is designated generally by the reference numeral 100, in block diagram form. In the preferred embodiment of FIG. 1, the apparatus 100 includes a User computer 10 which is associated with a user of the apparatus and method of the present invention in order to engage, locate, find, buy, purchase, and/or otherwise use the Internet, engage in commerce, and/or in a transactions, involving any goods and/or services which can be obtained via the apparatus 100. Any number of User computers 10 can be utilized with the apparatus 100 of the present invention.

The apparatus 100 also includes a Electronic Affinity Library Membership computer 20 which is associated with Electronic Affinity Library provider for providing and/or facilitating electronic frequent shopper affinity relationships and/or information and/or other content to a respective User along with providing links to various merchants, sellers, vendors, advertisers, marketers, and/or other parties and/or entities described herein. Any number of Content Provider computers 20 can be utilized with the apparatus 100 of the present invention.

The apparatus 100 also includes a Merchant computer 30 which is associated with any of the merchants, sellers, vendors, marketers, and/or any other parties and/or entities, who or which sell or provide goods and/or services in commerce via the apparatus 100 of the present invention. Any number of Merchant computers 30 can be utilized with the apparatus 100 of the present invention.

The apparatus 100 can also include any number of central processing computers 50.

The various User computers 10, Electronic Affinity Library Membership computers 20, Merchant computers 30, and the Advertiser Computer 40, as well as the central processing computers 50 described herein below, can engage in bi-directional communication with every other computer 10, 20, 30, 40, and 50, on or over a suitable communication network. Each of the computers can include associated and/or suitable central processing units (CPUs), Random Access Memories (RAMs), Read Only Memories (ROMs), databases, user input devices, storage devices, removable storage devices, output devices, transmitters, receivers, and/or any other hardware and/or software which can be necessary and/or which can be desired in order to perform the operations and functionality described herein.

In the preferred embodiment, the apparatus 100 is utilized on, over, and/or in conjunction with, the Internet, the World Wide Web, a telephone communication network or system, a telecommunication network or system, a satellite communication network or system, a wireless communication network or system, a radio communication network or system, a digital or analog satellite communication network or system, a personal communication services communication network or system, a global standard for mobile (GSM) communication network or system, a cable television network or system, a broadband communication network or system, and/or any other appropriate communication network or system.

In the preferred embodiment, the User computer 10 can be any computer and/or communication device for allowing an individual to access the Internet, the World Wide Web, and/or any other computer or communication device which can be utilized in a communication network. The User computer 10 can be any one or more of a personal computer, a personal digital assistant, a telephone, a personal communications device, an interactive television, a television, Digital Personal Assistant (PDA), an electronic book device, a network computer, and/or any other appropriate communication device.

In the preferred embodiment, the Electronic Affinity Library Membership Provider Computers 20 and/or the Merchant Computers 30 and/or the Advertiser Computers 40, can also be any suitable or appropriate computer and/or communication device, and preferably can be a network computer, a server computer, and/or an Internet server computer, for performing the processing and functionality described herein.

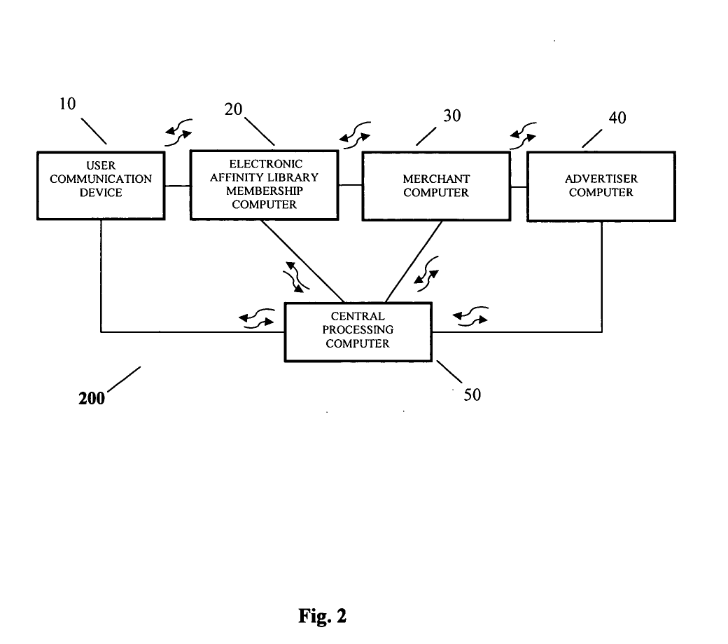

FIG. 2 illustrates another preferred embodiment of the apparatus of the present invention which is designated generally by the reference numeral 200. In the preferred embodiment of FIG. 2, the apparatus includes the User Computer 10, the Electronic Affinity Library Membership Provider Computers 20 and the Merchant Computers 30 described herein with reference to FIG. 1. The apparatus 200 can also include an Advertiser Computer 40 and a Central Processing Computer or Clearinghouse type Computer 50 (hereinafter “the central processing computer 50”). The central processing computer 50, as will be described herein, can be programmed to perform various processing routines for servicing any of the various and respective User Computers 10, Electronic Affinity Library Membership Provider Computers 20, Advertising Computers 40, and/or Merchant computers 30, described herein.

In the preferred embodiments of the present invention, the various User computers 10, Electronic Affinity Library Membership Provider Computers 20, the Merchant computers 30, Advertiser Computers 40 and/or the central processing computers 50, depending upon the preferred embodiment utilized, can be equipped any suitable hardware and/or software for performing their respective functions as described herein.

Each of various User computers 10, Electronic Affinity Library Membership Provider Computers 20, Merchant computers 30, Advertisers Computers 40, and/or central processing computers 50, can operate in accordance with the herein-described operations and methods of the present invention pursuant to software modules which contain instructions for allowing the respective computers to perform their respective operations and/or functionality as described herein. For example, the operation of a given preferred embodiment for utilizing the present invention can require that each of the various User computers 10, Electronic Affinity Library Membership Provider Computers 20, Merchant computers 30, Advertiser Computers 40, and/or central processing computers 50, perform certain respective functions. For example, the User computer(s) can be equipped with the Frequent Shopper Library Toolbar software, as well as, suitable browser software and/or with any other software needed to perform any of the functions described herein as being performed by the User computers 10.

The Electronic Affinity Library Membership Provider Computers 20 can be equipped with suitable software to provide an Electronic Frequent Shopper Toolbar Button and/or to present an advertisement, to provide a suitable link to a respective Merchant computer 30, and/or to provide a suitable link to a respective Advertiser computer 40 and/or to monitor User activity and/or traffic on, and/or through, its respective web site. The Content Provider computer 20 can also be provided with any other software which may be needed to perform any of the functions described herein.

The Merchant computer(s) 30 can be equipped with suitable software to process transactions, to record User information, to ascertain and/or identify referring Electronic Affinity Library Membership Provider Computers 20, to record and maintain transaction and/or referral records and/or information. The merchant computer 30 can also be provided with any other software which may be needed to perform any of the functions described herein.

The central processing computers 50 can similarly be equipped with any software needed in order to perform any of the functions described herein as being performed by the central processing computers 50.

The present invention employs current Internet and/or World Wide Web links, hyperlinks, and/or linking or hyperlinking techniques, methods, and/or devices, such as those utilized in conjunction with banner advertisements, icon advertisements, logo advertisements, text advertisements, highlighted text advertisements, etc. and/or any other entities or devices which contain and/or include embedded code which creates a link from one web site, host computer, or file, to another web site, host computer, or file. In this manner, a respective user can be linked, on, over, and/or across, the Internet and/or the World Wide Web, from one computer (such as, for example, a Electronic Affinity Library Membership Provider Computers 20) to another computer in the network (such as, for example, a Merchant computer 30).

The apparatus and method of the present invention can be utilized so as to facilitate frequent shopper affiliated marketing and/or rewards relationships and/or programs. In this regard, the present invention can provide an apparatus and/or system, and an associated method, wherein an Electronic Affinity Library Membership Provider Computers 20 or web site can provide advertisements containing embedded links to a Merchant computer 30 or web site of a merchant selling and/or otherwise offering goods and/or services in commerce. When a user accesses the Electronic Affinity Library Membership Provider Computers 20 or web site, he or she can link to the Merchant's computer 30 or web site via an advertisement banner, text, icon, logo, and/or other advertisement. The link can be a direct link to the Merchant's computer 30 or web site. The link can also be an indirect link to the Merchant's computer 30 or web site and/or an Advertiser's computer 40 or web site, either of which may direct the User through various parties, computers, and/or web sites, which may be affiliated with the respective Content Provider and/or with the respective Merchant. This indirect linking scenario can be the basis by which to facilitate advertising other affiliated marketing relationships and/or co-branding relationships.

The user will then be linked to the Merchant's computer 30 or web site. During the linking process, data and/or information identifying the User, the Electronic Affinity Library Membership Provider Computers 20 or web site, and/or Advertiser Computer 40 or web site, and/or any other pertinent data and/or information, can be transferred to the Merchant computer 30 or web site. For example, the User can have a query string or identifying information appended to his or her HTTP entry and/or other data and/or information entry. The User can also have a cookie or file placed on his or her User computer 10.

The Merchant computer 30 or web site can also query and/or inquire or “ping” the relevant network, or use any other techniques known by those skilled in the art, in order to ascertain the identity of the referring Electronic Affinity Library Membership Provider Computers, server, or web site, and/or so as to track the User's movement, viewing or navigation to the Merchant's computer 30.

If the user makes a purchase from, or engages in a transaction with, the Merchant's computer 30 or web site, the Merchant computer 30 can identify and notify the Electronic Affinity Library Membership Provider Computers 20 of the sale or transaction and update the consumer shopping and/or purchasing data and/or Electronic Affinity Library Membership Provider Computers 20. The Merchant, via the Merchant computer 30 and/or otherwise, can also update Electronic Affinity Library Membership Provider purchasing data and/or to the Electronic Affinity Library Membership Provider Computers 20.

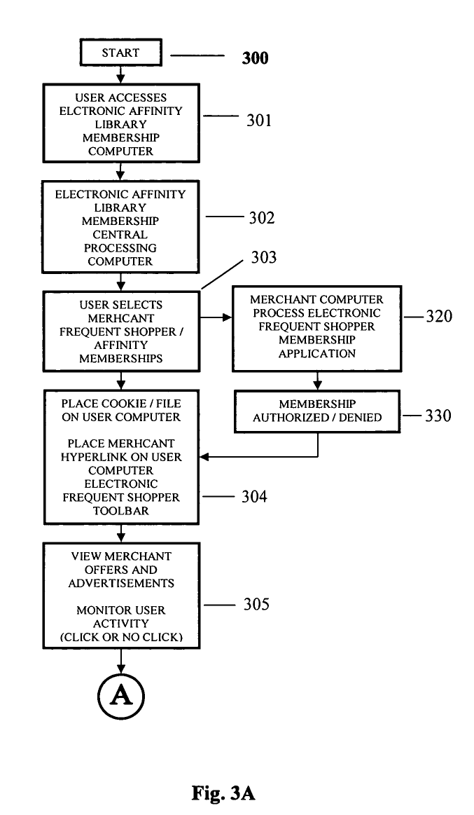

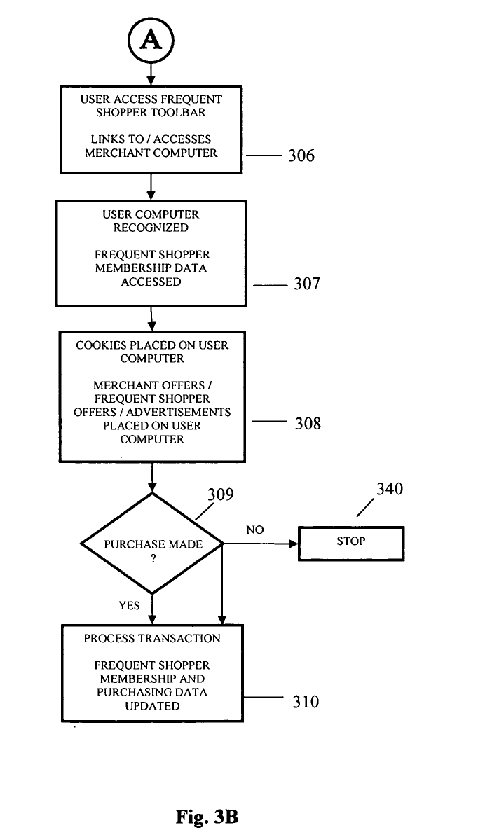

FIGS. 3A and 3B illustrate a preferred embodiment operation of the apparatus 100. With reference to FIGS. 3A and 3B, the operation of the apparatus 100 commences at step 300. At step 301, the user accesses the Electronic Affinity Library Membership Provider Computers 20, via the User computer 10. The User computer 10, in the preferred embodiment, can be equipped with any appropriate Internet browser software for allowing the User to link to any of the various Electronic Affinity Library Membership Provider Computers 20 which can be accessed via the Internet, the World Wide Web, and/or the communication network on, and/or over, which the apparatus 100 is utilized.

The Electronic Affinity Library Membership Provider Computers 20 or web site can provide various information and/or services, including, but not limited to, Internet service provider information and/or services, Internet portal information, advertising, and/or services, news information and/or services, auction services, financial information, sporting information, hobby information, special interest information, chat room services, e-mail services, and/or any other information and/or services which can be offered via a web site, network computer, or server computer, over the Internet, the World Wide Web, or other communication network.

Electronic Affinity Library Membership Provider Computers 20, in the preferred embodiment, also contains advertisements on the associated web site(s) and/or on any of the web page(s) associated with, and/or forming a portion of, same. The advertisements can be banner advertisements, text advertisements, logo advertisements, icon advertisements, and/or any other advertisements. In the preferred embodiment, the above-identified advertisements will contain embedded code which provides information for linking the User computer 10, via the Electronic Affinity Library Membership Provider Computers 20, to the Merchant computer 30 and/or the Advertising computer 40, associated with the Merchant and/or advertiser who has either placed the advertisement(s) and/or who is associated with the goods and/or services provider who or which offers the respective goods and/or services being advertised. An example scenario for illustrating the above is provided as follows.

A User, via a User computer 10, can access the Electronic Affinity Library Membership Provider Computers 20 which is associated with merchant CVS, Inc. CVS, Inc. provides personal care and pharmacy services. On the CVS web page, the User can see a banner advertisement, an icon advertisement, a logo advertisement, a text advertisement, and/or any other advertisement, for a product or service which can, for example, be an advertisement for over the counter medications. The User can click on the respective advertisement and thereafter be linked to the Merchant computer 30 of the merchant advertising the goods for sale.

At step 302, the Electronic Affinity Library Membership Provider Computers 20 can place a cookie or associated files on the User's computer 10 so as to track a subsequent interaction with, visit by, and/or activity with, the User. At step 303, the User can select from a menu of one or more electronic and/or in-store frequent shopper affinity programs. At step 303 the User can view the advertisements on the Electronic Affinity Library Membership Provider web site. At step 303, the User can click on and/or select any of the advertisements. If, at step 303, the User leaves the Electronic Affinity Library Membership Provider Computers 20 or web site without clicking on or enrolling into an electronic or in-store type frequent shopper or affinity program, or if the Merchant Computer 320 the operation of the apparatus 100 will cease at step 320, after depositing cookies or associated files on the User's computer 10.

If, at step 303, the User clicks on or selects an advertisement, or otherwise enrolls into a electronic or in-store type frequent shopper affinity program, Electronic Affinity Library Membership Provider Computers 20 will, at step 304, create a file for the User and record information regarding the User, the User ID, place a hyperlink to the Merchants Computer 30, the date and time of the User access to the Electronic Affinity Library Membership Provider Computers 20, the time and date of any click on and/or any selection of any Merchant displayed advertisement, the Merchant associated with the advertisement, the site address of the merchant, the indicated shopping preferences of the consumer and/or any other information which can be related to, and/or which can be of interest to the Electronic Affinity Library Membership Provider, Merchant or Advertiser.

At step 305, the User computer 10 will then be linked to the Merchant computer 30 or web site, via the Internet, the World Wide Web, and/or any other communication network. At step 305, the Merchant computer 30 will ascertain the identity of the user and/or the User computer 10 and the Electronic Affinity Library Membership Provider Computers 20 or web site from which the user and User computer 10 was referred. Information regarding User ID, time and date of the visit to, and/or access to, the Merchant computer 30, can be transmitted and/or can be transferred to the Merchant computer 30 along with User source information and/or query string(s) and/or pings and/or any other relevant data and/or information indicative of the communication and/or transfer, to the Merchant computer 30.

The User computer 10 can also have a query string(s) and/or pings, appended to its HTTP entry and/or other data and/or information entry. The User can also have a cookie or file placed on his or her User computer 10 by the merchant computer 30 and/or the Advertisers computer 40. The Merchant computer 30 or web site can query and/or “ping” the relevant network, or use any other techniques known by those skilled in the art, in order to ascertain the identity Electronic Affinity Library Membership Provider Computers 20 and/or the advertiser computer 40, server, or web site, and/or so as to track the User's movement or navigation to the Merchant computer 30 for ascertaining the last Electronic Affinity Library Membership Provider Computers 20 and/or Advertiser computer 40, network computer, and/or server computer.

If the user makes a purchase and/or enters into a transaction at the Merchant's computer 30 or web site, the Merchant computer 30 can identify and notify the Electronic Affinity Library Membership Provider Computers 20 of the sale and update the shopper records of the Electronic Affinity Library Membership Provider Computers and/or the Advertiser records.

At step 306, the Merchant computer 30 can place a cookie or associated file on the User's computer 10 so as to track a subsequent interaction with, visit by, and/or activity with, the User. At step 306, the User can purchase a good or service, and/or enter into a transaction with the Merchant, from the Merchant computer 30 or web site. At step 307, the Merchant computer 30 will determine whether the User made a purchase from, and/or entered into a transaction with, the Merchant. At step 308, cookies and/or merchant offers and/or frequent shopper offers and/or advertisements will be placed on the Users computer 10. If, at step 309, it is determined that the User did not make a purchase from, and/or did not enter into a transaction, and/or did not complete a transaction, with the Merchant computer 30 or web site, the operation of the apparatus 100 will cease at step 340, but the Electronic Affinity Library Membership Provider Computers 20 and the Merchant computer 30 will still be updated with any data and/or information that can be derived by reason of the User's clicking on advertisements and/or on links and/or visits to other shopping websites. If, however, at step 309, it is determined that the User did make a purchase from, and/or that the User entered into a transaction with, and/or completed a transaction with, the Merchant computer 30 or web site, the Merchant will process the transaction, at step 310. The transaction and/or other event can be processed by the Merchant computer 30 and/or by any other computer associated with the Merchant computer 30 and/or the Merchant. Thereafter, at step 310, the Merchant computer 30 will generate update the consumer's shopping history and/or preferences for use in transmitting future frequent shopping rewards and/or transmitting shopping offers, and/or transmitting and/or arranging for the transmission of relevant and/or related advertising from an Advertiser's computer 40 or the Merchant's Computer 30.

The Merchant computer 30 can include a database (not shown) which can store the specific terms and/or conditions of the Electronic Affinity Library Membership Provider Computers 20 and/or special frequent shopper offers, including commissions and/or referral fees which are to be paid to the Merchant from the advertisers.

At step 310, the Merchant computer 30 can calculate the commission(s) and/or referral fee(s), due to the Merchant by an advertiser, whichever the case may be, by utilizing any of the herein-described data and/or information in any manner dictated by the respective affiliated marketing relationship or agreement which governs the relationship.

At step 310, the Merchant computer 30 can transmit a transaction record to the referring Electronic Affinity Library Membership Provider Computers 20 thereby providing the Electronic Affinity Library Membership Provider and/or the Electronic Affinity Library Membership Provider Computers 20 with a transaction notification report which notifies the Electronic Affinity Library Membership Provider to update the User's shopping records and shopping preferences referring the User to the Merchant computer 30 or web site. In any and/or all of the embodiments described herein, any of the transaction notification reports described herein can be transmitted to the referring content provider(s) in real-time and/or otherwise.

In another preferred embodiment, the Merchant computer 30 can also transmit the transaction notification report to the central processing computer 50 which can monitor transactions which occur between any number of Merchants and/or Merchant computers 30 and/or Electronic Affinity Library Membership Provider Computers 20 and/or Advertisers computers 40.

At step 311, the transaction notification report can be utilized by the Electronic Affinity Library Membership Provider for consumer purchasing history and/or consumer preference recording purposes. Thereafter, the Merchant computer 30 can, at step 310, store information regarding the User, the Content Provider, the number of referrals obtained from the any merchant and/or advertiser. The operation of the apparatus 100 will thereafter cease at step 310.

In another preferred embodiment, the present invention can be utilized in conjunction with the central processing computer or clearinghouse computer 50 of FIG. 2. In this preferred embodiment, the Merchant computer 30 can transmit any and/or all transaction data and/or information described herein, such as sums due, and/or to be paid to, the respective Merchants, to the central processing computer 50. The Merchant computer 30 can also transmit data and/or information regarding the User, the Merchant and to the central processing computer 50.

In the above-described manner, the apparatus and method of the present invention can facilitate electronic and in-store type affiliated marketing relationships between Content Providers and Merchants.

In another preferred embodiment, the apparatus and method of the present invention can be utilized in conjunction with the central processing computer 50 so as to facilitate the creation of advertising and/or co-branding relationships between the various parties and/or for maintaining records, financial and/or non-financial, for any of these respective parties and/or the respective and/or resulting relationships.

The central processing computer 50 includes a database (not shown) which can store Merchant advertisements and/or advertising information and/or advertising from third parties. The merchant advertisement and/or advertising information can include advertisements which the Merchant wishes to offer to the consumer. These advertisements and/or advertisement information can include advertisement modules which can contain banner, logo, icon, and/or text advertisement information together with embedded code(s) for providing links to, and/or for linking to, the respective Merchant computer 30 or web site. These advertisement modules can be downloaded from the central processing computer 50 and/or from an Advertiser's computer 40 to an Electronic Affinity Library Membership Provider Computers 20, via the Internet, the World Wide Web, and/or other communication network, and can be placed on the Content Provider's computer 20 and/or web site.

The database can contain advertisements which are offered from the various Merchants participating in an Electronic Affinity Library Membership program. The database can also contain advertising space which is available for sale or rent by Electronic Affinity Library Membership Provider and/or Merchants. The database can also contain the terms or conditions, including but not limited to, payment amounts, and/or commissions associated with the various advertisements, advertisement terms and/or conditions, including but not limited to, fees, commissions associated with available advertising space, terms for automatic acceptance of the any of the herein-described advertisements and/or advertisement space, the number of visits and/or hits on an advertisement banner, logo, icon, and/or text, obtained by the Electronic Affinity Library Membership Provider, the number of sales and/or completed transactions obtained from an advertisement in relation to the number of visits or hits for a particular advertisement and/or for a given consumer, the commissions and/or referral fees paid by a Merchant(s) to an Advertiser, the amount of commissions and/or referral fees paid to Electronic Affinity Library Membership Provider, transactions involving commissions and/or referral fees being earned by Electronic Affinity Library Membership Provider as well as when these commissions and/or referral fees are paid.

The database can also contain data and/or information regarding the availability of advertisements and/or the availability of advertising space, and/or the expiration of advertisements as well as the expiration and/or the unavailability of advertising space.

The database can also contain contact information for any of the respective Merchants together with criteria and/or events, the occurrence of which they desire to be notified. These criteria, events and/or occurrences, can include, but not be limited to, the availability of advertising space by a Electronic Affinity Library Membership Provider, changes in prices of advertising space, changes in terms and/or conditions for advertising space, and/or any other event(s) or occurrence(s) which may be of interest to a Merchant and/or Advertiser.

The database can also contain contact information for any of the respective Merchants and/or advertisers along with criteria and/or events, the occurrence of which they desire to be notified. These criteria, events and/or occurrences, can include, but not be limited to, a request for advertising space by a certain Merchant(s), changes in offered prices for advertising space, changes in terms and/or conditions for an advertising offering, a sale or transaction resulting in a commission and/or referral fee earned by a respective party, an effected payment, and/or a deposit, of any commission and/or fee to a respective party and/or into the respective party's financial account, and/or any other event(s) or occurrence(s) which may be of interest to a Electronic Affinity Library Membership Provider and/or Merchant and/or advertiser.

The database can also contain contact information for any of the respective Users together with criteria and/or events, the occurrence of which they desire to be notified. These criteria, events and/or occurrences, can include, but not be limited to, the notification of a price reductions, product introductions, changes in merchant affiliations, advertisement debut, the introduction of an advertisement and/or an advertising campaign by a specified Merchant or Merchants and/or for a specified good(s) and/or service(s), the offering of a specified good(s) and/or service(s) at a specified price(s) and/or under certain term(s) and/or conditions, changes in terms and/or conditions, and/or price(s) and/or offering(s) of a good(s) and/or service(s), and/or any other event and/or occurrence which may be of interest to a User.

The database can also include data and/or information concerning the past success rates for a particular advertisement(s), as well as sales success rates for particular Merchants. The database can also contain any other data and/or information for providing and/or for facilitating any of the functions and/or services described herein as being performed by the apparatus and method of the present invention, the User computers 10, the Content provider computers 20, the Merchant computers 30, the Advertiser's computer 40 and/or the central processing computers 50.

Any of the herein-described Merchants, Advertisers, Users and/or operators of the central processing computer 50 and/or Electronic Affinity Library Membership Providers, can enter requests for receiving notification for any pre-defined event or occurrence, and/or can enter any other criteria for receiving notification, into the central processing computer 50, via any of their respective computers. Notification requests can be effected in real-time and/or otherwise.

Any and/or all of the data and/or information which are stored in the database can be entered and/or can be updated in real-time and/or otherwise.

In any and/or all of the embodiments described herein, any and/or all of the data and/or information can be transmitted by and between any of the respective User computers 10, the Content Provider computers 20, the Merchant computers, the Advertisers computers 40 and/or the central processing computers 50. These transmissions and/or communications which take place between any of the respective computers 10, 20, 30, 40 and/or 50, can be transmitted and/or can occur in real-time and/or otherwise. Further, in any and/or all of the embodiments described herein, any of the described data and/or information which is described as being transmitted from, to, and/or between, any of the respective computers and/or parties, can be in the form of, or as part of electronic mail (e-mail) messages, electronic mail attachments, electronic message transmissions or electronic notification transmissions, and/or via any other mode of communication.

In any and/or all of the embodiments described herein, any of the data and/or information stored in the database of the central processing computer 50 can be accessed by any one or more of the respective Users and/or User computers 10, the Electronic Affinity Library Membership Providers and/or Electronic Affinity Library Membership Provider Computers 20, and/or the Merchants and/or Merchant computers 30, the Advertisers and/or the Advertisers computers 50, in real-time and/or otherwise. Further, the purchase and/or sale of any of the herein-described advertisements can be performed, via the central processing computer 50, and/or Electronic Affinity Library Membership Provider Computers 20, in real-time and/or otherwise.

In another preferred embodiment, the apparatus 200 can provide a clearinghouse for Merchants desiring to obtain advertising space, an advertising banner, an advertising logo, an advertising icon, an advertising text, and/or any other advertising device and/or services. In this embodiment, the Merchant can query the database of the central processing computer 50, and/or the database(s) of any of the Electronic Affinity Library Membership Provider Computers 20, which can contain and/or store the same data and/or information as stored in the database of the central processing computer 50, and/or otherwise ascertain and/or review the availability of advertisement spaces and/or services, made available by and/or offered by various merchants and/or advertisers and/or Electronic Affinity Library Membership Providers.

The database can contain information concerning the advertisement space, the merchant and/or Advertiser offering the same, advertisement rates, commissions and/or other terms and conditions of the advertisement offerings. Thereafter, the Merchant can select and purchase any desired advertisement space and/or services from the respective Advertisers and/or Electronic Affinity Library Membership Providers. Thereafter, the parties can contact one another, via information and/or links provided by the central processing computer 50 and/or otherwise. In another embodiment, the central processing computer 50 can generate and transmit an e-mail message to the respective Advertiser and/or Merchant informing the Advertiser and/or Merchant that its advertisement space(s) has, and/or that its advertising services have, been purchased.

The Merchant's advertisement file can then be provided to Advertiser and/or Electronic Affinity Library Membership Provider for inclusion on its computers 20 or web site, and/or the advertisement file can be downloaded, via the Internet, the World Wide Web, and/or any other communication network, from the Merchant's computer 30 and/or from the central processing computer 50, if stored thereon.

In another preferred embodiment, the apparatus 200 can provide a clearinghouse for Advertisers desiring to sell advertising space and/or services to Merchants. In this embodiment, the Electronic Affinity Library Membership Provider can query the database of the central processing computer 50, and/or the database(s) of any of the Merchant computers 30 which can contain and/or store the same data and/or information as stored in the database of the central processing computer 50, and/or otherwise review requests for, and/or orders for advertisement space and/or services, which are placed by the various Merchants.

The database can contain information concerning the type of advertisement space or services desired, the Merchant requesting same, advertisement rates, commissions, to be paid by the Merchant, and/or other terms and conditions of the advertisement request. Thereafter, the Electronic Affinity Library Membership Provider can select the advertisement request or offer which it desires to accept and/or fulfill. Thereafter, the parties can contact one another, via information and/or links provided by the central processing computer 50 and/or otherwise. In another embodiment, the central processing computer 50 can generate and transmit an e-mail message to the respective Merchant informing the Merchant that an Electronic Affinity Library Membership Provider has agreed to sell it or otherwise provide it with advertisement space and/or services.

The Merchant's advertisement file can then be provided to the Electronic Affinity Library Membership Provider Computers 20 for inclusion on its computer 20 or web site, and/or the advertisement file can be downloaded, via the Internet, the World Wide Web, and/or any other communication network, from the Merchant's computer 30 and/or from the central processing computer 50, if stored thereon.

In another preferred embodiment, Electronic Affinity Library Membership Provider Computers 20 can auction advertisement space and/or services and/or make counteroffers to Merchants in response to offers for advertisement space and/or services. In this embodiment, the respective Merchants can bid for advertisement space and/or services, and/or make counter offers for same.

In any and/or all of the embodiments described herein, any of the data and/or information described as being stored in the database of the central processing computer 50 can be transmitted to the central processing computer 50 by any of the respective Electronic Affinity Library Membership Provider Computers 20 and/or Merchant computers 30 and or Advertiser computers 40. Once an affiliated marketing relationship is established, via an Electronic Affinity Library Membership Provider Computer 20 and/or the central processing computer 50 and/or otherwise, the apparatus and method of the present invention, as described with reference to FIG. 3, can be utilized in order to effectuate and/or facilitate the affiliated marketing relationship between the parties.

The apparatus and method of the present invention can be utilized in order to provide or effectuate affiliated marketing relations for the sale of any goods and/or services, tangible as well as intangible, which can and/or which may be the subject of commerce and/or of a transaction. These goods and/or services can include, but are not limited to, clothing, apparel, foods, sporting goods, books, toys, insurance products and services, real estate services, real estate, rental properties, real estate for sale, insurance products and services, health insurance products and services, life insurance products and services, disability insurance products and services, group insurance products and services, group health insurance products and services, group life insurance products and services, employee benefits products and services and/or packages, executive compensation products and services and/or packages, liability insurance products and services, casualty insurance products and services, property insurance products and services, malpractice insurance products and services, director and officer liability insurance products and services, automobile products and services, boat products and services, aircraft products and services, automobile parts products and services, automobile repair services, furniture products and services, vacation packages, vacation products and services airline products and services and/or airline tickets, rail tickets, boat tickets, medical products and services medical supplies, dental products and services and/or supplies, construction products and services and/or supplies, home improvement products and services and/or supplies, entertainment products and services and/or tickets, fitness and/or wellness products and services, exercise and/or recreational equipment, medical services, legal products and services, consulting products and services, profession and/or non-professional products and/or services of any kind or type, recruitment products or services, staffing products or services, secretarial services, contracting services, real estate products and services, accounting products or services, computer products and/or services, software products and/or services, education products and/or services, instructional products and/or services, communication products and/or services, telecommunication products and/or services, electrical utility products and/or services, telephone utility products and/or services, gas utility products and/or services, fuel utility products and/or services, wireless telephone products and/or services, management products and services, human resource management products and/or services, payroll processing products and/or services, financial transaction processing products and/or services, financial transaction notification and/or monitoring products and/or services, security products and/or services, home, premises, vehicle and/or personal security products and/or services, brokerage products and/or services, client relationship management products and/or services, consulting products and/or services, business products and/ore services, outsourcing products and/or services of any kind, insurance brokerage products and services, financial products and services, government sponsored medical benefits, Medicare and Medicaid services and/or any other kind of goods, products, and/or services, which can be sold, purchased, bartered and/or traded, in any transaction and/or which can be the subject of commerce and/or of a transaction of any kind.

The present invention can also be utilized as a component part of customer relationship management tools and/or systems and/or software as well as in client relationship management tools, systems and/or software.

In any and/or all of the embodiments described herein, the apparatus and method of the present invention can be implemented with general purpose computers and/or network computers, and suitable communication equipment, along with respective modular software packages which facilitate the operation of each of the respective computers 10, 20, 30, 40 and 50 in performing their respective functions and/or functionality.

In another preferred embodiment, as well as in any of the embodiments described herein, intelligent agents, software agents, mobile agents, and/or related technologies, can be utilized in conjunction with the present invention. The respective intelligent agent(s), software agent(s), mobile agent(s), (hereinafter referred to collectively as “intelligent agent” or “intelligent agents”) can be programmed and/or designed to act on behalf of the respective Users, Electronic Affinity Library Membership Providers, Advertisers, Merchants, and/or central processing computer operators, and/or the respective computers 10, 20, 30, 40 and/or 50.

The intelligent agent can act on behalf of the respective party or parties in various related transactions, interactions, and/or other activities, which are described as being performed herein and/or which may be incidental to and/or which may be related thereto. Therefore, the present invention also provides an agent-based apparatus and method for effectuating an affiliated marketing relationship.

The apparatus of the present invention, in any and/or all of the embodiments described herein, can also be programmed to be self-activating and/or can be activated and/or terminate and/or shut down automatically.

The present invention provides an apparatus and a method for effectuating an Electronic Affinity Library Membership program and a toolbar therefore and/or affiliated marketing relationship and, in particular, to an apparatus and a method for providing, effectuating, and/or facilitating, affiliated marketing relationships and/or programs. The present invention also provides an apparatus and a method for calculating commissions and/or fees pursuant to the affiliated marketing relationship and can provide for the monitoring, the tracking, and/or the management of, affiliated marketing relationships, referral relationships, and/or other commerce and/or related relationships.

The present invention also provides an apparatus and a method for facilitating the buying and/or selling of advertisement space by and/or between any of the respective parties and/or entities described herein.

The present invention can also provide an apparatus and a method for receiving and/or for storing various affiliated and/or frequent shopping marketing data and/or information which can provide valuable market, market research, and/or marketing, data and/or information, which can or may be utilized by various parties in finding and/or identifying suitable affiliated marketing counterparts and/or suitable affiliated marketing relationships. The market, market research, and/or marketing, data and/or information, can be utilized by a Merchant(s) to find and/or to identify a suitable Advertisers(s) and/or Electronic Affinity Library Membership Provider and/or the present invention can be utilized by a Electronic Affinity Library Membership Provider(s) so as to find and/or to identify a suitable Merchant(s) and/or customer(s).

The apparatus of the present invention can also be programmed in order to automatically generate and/or transmit any of the e-mails, electronic message transmissions, electronic notification transmissions, telephone calls, pager transmission and/or messages, and/or any of the other communications, which are described herein, between any of the parties which utilize the present invention.

The present invention, in any and/or all of the herein-described embodiments, can utilize electronic commerce technologies and security methods, techniques and technologies, as described and as set forth in Electronic Commerce Technical, Business, and Legal Issues, Nabil R. Adam, et al. Prentice Hall, 1999 and Web Security & Commerce, Simson Garfinkel with Gene Spafford, O'Reilly 1997, the subject matter of which are hereby incorporated by reference herein.

Other objects and advantages of the present invention will be apparent to those skilled in the art upon a review of the Description of the Preferred Embodiments taken in conjunction with the Drawings.

What is claimed is:

1. An apparatus for providing at least one of an electronic affinity frequent shopping computer program, together with purchasing rewards, purchasing histories, marketing, advertising and promotions to consumers using the Internet to make purchases, said apparatus comprising:
A memory device for storing at least one of account information, account purchasing history, purchasing rewards history, marketing information, advertising information and promotional information;
At least one processor for transmitting a computer program to the electronic affinity shopping rewards account holder's computational apparatus wherein, the at least one processor stores and displays at least one of an electronic affinity frequent shopper account toolbar having at least one shopper preferred electronic shopping link and hyperlink.
At least one processor for detecting the generation of at least one electronic affinity shopping library account, electronic statement and an electronic account correspondence, wherein the processor identifies and selects at least one frequent purchaser reward and selects at least one of marketing materials, advertising materials and promotional materials to be provided with at least one electronic affinity shopping library enrollment notification, electronic affinity library shopping statement, a frequent purchasing reward statement and an electronic affinity library enrollment discount having a special offer and an electronic correspondence, and further wherein the processor generates at least one library enrollment discount, a frequent purchaser reward, marketing materials, advertising materials and promotional materials and an output device for outputting the at least one of an electronic affinity library frequent purchasing reward.

2. The apparatus of claim 1, wherein the at least one electronic enrollment into an electronic affinity shopping program library creates at least one new frequent shopping rewards account using new consumer data.

3. The apparatus of claim 1, wherein the at least one electronic enrollment into an electronic affinity shopping library program creates at least one new account using at least one of historical and preexisting consumer account data.

4. The apparatus of claim 1, wherein the at least one of an electronic enrollment into an electronic affinity frequent shopping library program creates at least one of a new account linked to an existing in-store frequent shopping affinity rewards account and further wherein the at least one of an electronic enrollment into an electronic affinity frequent shopping library program accesses and uses historical consumer data.

5. The apparatus of claim 1, wherein the processor generates at least one electronic affinity frequent shopping library program statement and generates an electronic account correspondence and further wherein the output device outputs the at least one electronic affinity frequent shopping library program statement.

6. The apparatus of claim 1, wherein the account is at least one electronic affinity frequent shopper library account, a frequent shopper reward account and further wherein the account is at least one of an electronic affinity frequent shopper electronic rewards account and an in-store affinity frequent shopper rewards account.

7. The apparatus of claim 1, wherein the at least one processor identifies and selects at least one of marketing materials, advertising materials and promotional materials, from at least one of merchant selected information, advertiser selected information and frequent shopper shopping information and further wherein the account is at least one of an electronic affinity frequent shopping library account holder shopping history information and preferences.

8. The apparatus of claim 1, wherein the output device is a printer.

9. The apparatus of claim 1, further comprising a receiver for receiving at least one of the electronic affinity shopping library account holder's shopping history, related marketing materials, advertising materials, and promotional materials and consumer instructions for receipt of the at least one of marketing materials, advertising materials, and promotional materials.

10. The apparatus of claim 1, wherein the computational apparatus is at least one of a computer, a computer system, a network computer, and a server computer.

11. An apparatus for providing at least one of an electronic affinity frequent shopping library account shopping history, related advertising, promotional materials, and information together with the at least one of an electronic affinity shopping library account shopping history statement, and an account correspondence comprising:
A memory device for storing at least one of an electronic affinity shopping library account information, electronic affinity account shopping library information, marketing information, advertising information, and promotional information related to the shopping history and preferences of the electronic affinity account shopping library account holder;
At least one processor for detecting the generation of at least one electronic affinity shopping library account statement and a library account correspondence, wherein the processor identifies and selects at least one of marketing materials, advertising materials and promotional materials, to be provided with the at least one electronic affinity card shopping library account statement and an electronic affinity shopping statement, and further wherein the processor generates at least one of marketing materials, advertising materials, and promotional materials, and promotional materials to a communication device associated with an electronic affinity shopping rewards library account holder.

12. The apparatus of claim 11 wherein the processor generates at least one of marketing materials, advertising materials and promotional materials, as at least one of an electronic mail message and as an attachment to an e-mail message.

13. The apparatus of claim 11 wherein the at least one of marketing materials, advertising materials, and promotional materials, contains at least one of an Internet web address and a hyperlink to at least one of a merchant, a vendor, an advertiser, and information regarding at least one of a good, a product, a service, information, and further wherein the at least one marketing materials, advertising materials, and promotional materials, contains at least one of an Internet web address and a hyperlink to at least one merchant, vendor, advertiser, and information that is related to the consumer's affinity shopping library accounts and the consumer's shopping preferences.

14. The apparatus of claim 11, wherein the account is at least one of an electronic affinity shopping library account.

15. The apparatus of claim 11, wherein the account is at least one of, an in-store frequent shopper rewards account.

16. The apparatus of claim 11, wherein the account is at least one of a combined electronic affinity shopping library account and an in-store frequent shopping rewards account.

17. The apparatus of claim 11, wherein the processor identifies and selects the at least one of marketing materials, advertising materials and promotional materials, from merchant selected information, advertiser selected information; and further wherein the processor identifies and selects the at least one of marketing materials, advertising materials and promotional materials is based upon the electronic affinity shopping library account holder shopping history and shopping preferences and wherein the processor links the apparatus with a user's computational apparatus by means of a toolbar having at least one shopper preferred electronic shopping link and hyper-link.

18. The apparatus of claim 11, further comprising a receiver for receiving the at least one of marketing materials, advertising materials and promotional materials, merchant instructions for disseminating the at least one of marketing materials, advertising materials and promotional materials and further wherein the merchant instructions for disseminating the at least one marketing materials, advertising materials and promotional materials is based upon the electronic affinity shopping library account holder shopping history and shopping preferences.

19. A method for providing an electronic affinity shopping library account toolbar comprising:
creation of at least one of an electronic affinity shopping library account on a user computational apparatus;
storing at least one of account information, account statement information, marketing information, advertising information, and promotional information;
detecting the creation of at least one of an electronic affinity shopping library account, and generating of at least one electronic affinity library account statement and an account correspondence;
identifying and selecting at least one of marketing materials advertising materials, and promotional materials, to be provided with the at least one of an electronic affinity shopping library account statement and account correspondence;
generating the at least one of marketing materials, advertising materials and promotional materials;
outputting at least one of marketing materials, advertising materials and promotional materials;
transmitting the at least one of marketing materials, advertising materials, and promotional materials to a communication device associated with an electronic affinity shopping library account holder.

20. The method of claim 19, further comprised of generating the at least one of a frequent shopping merchant membership, marketing materials, advertising materials, and promotional materials, as at least one of an electronic mail message and attachment to an e-mail message.

21. The method of claim 19, further comprised of generating the at least one of an electronic affinity shopping library account statement and an account correspondence; and at least one of outputting and transmitting at least one of an electronic affinity shopping library account statement correspondence.

22. The method of claim 19, wherein the at least one of marketing materials, advertising materials, and promotional materials, contains at least one of an Internet address and a hyperlink to at least one of a merchant, a vendor, an advertiser, and information regarding at least one of a good, a product, a service, and information and further wherein such at least one of marketing materials, advertising materials, and promotional materials is selected based upon at least one of the consumer's electronic shopping library account shopping history and preferences.

23. The method of claim 19, wherein the at least one electronic affinity shopping library account is displayed on the user's computational apparatus on a frequent shopper account toolbar having at least one shopper preferred electronic shopping link and hyperlink.
